(19) United States
(12) Patent Application Publication
(10) Pub. No.: US 2005/0199239 A1
(43) Pub. Date: Sep. 15, 2005

(54) Mask cushioning and forehead pad for a respiratory mask, respiratory mask in addition to a mould and method for their production

(76) Inventors: Bernd Lang, GRAFELFING (DE); Achim Biener, Aufkirchen (DE); Martin Bechtel, Winsen/Luhe (DE)

Correspondence Address: NIXON & VANDERHYE, PC, 901 NORTH GLEBE ROAD, 11TH FLOOR, ARLINGTON, VA, 22203, US

(21) Appl. No.: 10/517,342

(22) PCT Filed: Jun. 16, 2003
(86) PCT No.: PCT/EP03/06334

§ 371 Date: Dec. 9, 2004

(30) Foreign Application Priority Data
Jun. 14, 2002 (DE) 102 26 587.9
Jun. 26, 2002 (DE) 102 28 554.3

(51) Int. Cl. A62B 18/08

(52) U.S. Cl. 128/206.24; 128/206.21

(57) ABSTRACT

The invention relates to mask cushioning for a respiratory mask, a respiratory mask, in addition to a method for their production. The aim of the invention, is to provide air-tight cushioning for a respiratory mask, in addition to a respiratory mask that is characterised by a sufficiently good air-tight action and is extremely comfortable to wear. This is achieved by a mask cushioning device for a respiratory mask, comprising a receiving opening, which corresponds at least to the nose and/or mouth region of a mask user, when the mask is worn and comprising a sealing lip that is configured from an elastomer material, surrounds the receiving opening and rests on the surface of the face of the mask wearer. The mask cushioning is characterised in that zones with an increased cross-section are configured in the mask cushioning and that the mask cushioning material in said zones has different material properties in such a way that the shore hardness of the mask cushioning in the border region is higher than that in the core region or at least close to said region. The invention also relates to a respiratory mask equipped with a corresponding mask cushioning device, in addition to a method and a mould for producing the same.

### FIELD OF THE INVENTION

The invention concerns a mask pad and a forehead pad for a breathing mask, a breathing mask in itself and a moulding tool and a process for the production of the mask. The invention concerns in particular mask pads and a breathing mask which is equipped with a mask pad of that kind and by which an internal space of a breathing mask in conjunction with the surface of the face of a user of the mask can be sealed off sealingly in relation to the ambient atmosphere in such a way that a pressure which is increased in relation to the ambient pressure can obtain at least in phase-wise fashion in the internal space of the breathing mask. Breathing masks of that kind are used in particular in connection with the medical or therapeutic administration of breathable gases and also in the technical sector, for example in the sector of breathing apparatus technology. The invention further concerns a sealing structure and a process for the production thereof in general.

Usually, with such breathing masks, the sealing action in relation to the surface of the face of the user of the mask is achieved by a sealing lip structure which extends in inwardly directed relationship around an opening of the mask and which is made from an elastically deformable material.

The sealing action achieved with sealing lips of that kind generally increases with the pressure with which the sealing lip is pressed against the surface of the face. In the case of comparatively high contact pressures, in particular long-term use of breathing masks of that kind can give rise to troubles.

### OBJECT OF THE INVENTION

The object of the present invention is to provide a sealing pad for a breathing mask and a breathing mask in itself, which is distinguished by a sufficiently high sealing effect and a high level of wearing comfort.

Attainment of the Object According to the Invention

In accordance with a first aspect of the present invention that object is attained by a mask pad device for a breathing mask comprising a receiving opening which in the position of application of the breathing mask coincides at least with the nose and/or mouth opening region of a user of the mask, and a sealing lip which is formed from an elastomer material and which extends around the receiving opening and which in the application position fits on the surface of the face of the user of the mask, wherein said mask pad device is distinguished in that zones of thickened cross-section are provided in the mask pad and that the mask pad material of said zones of thickened cross-section have different material properties in such a way that the Shore hardness and/or the density of the mask pad is higher in the edge region than in the region, which is at the core or at least near the core, of the zone of thickened cross-section.

In that way it is advantageously possible to provide a mask pad device which is distinguished by particularly high adaptability to the most widely varying individual face structures.

In accordance with a particularly preferred embodiment of the invention the mask pad device is of such a configuration that the Shore hardness of the mask pad in the region of the peripheral zone region which in the application position is near the forehead or the bridge of the nose is lower than in the region near the cheeks, top lip or sides of the nose.

In that way it is advantageously possible for the pad device to be supported, in particular in the region of the bridge of the nose, effectively and in elastically cushioned relationship in the forehead region or the region of the bridge of the nose.

Preferably the mask pad device is such that in the region of the zones of thickened cross-section the material has gel-like material properties.

The differing material properties in the region of the zones of thickened cross-section, in accordance with a particularly preferred embodiment of the invention, can be achieved in that hardening of the mask pad material is effected in such a way that the material has degrees of material crosslinking which differ in zone-wise manner.

The above-mentioned zones of thickened cross-section can be provided in the mask pad device in such a way that they directly adjoin the sealing lip. In that way it is possible for the function of the sealing lip to be limited essentially to affording a sufficient sealing action and it is possible for the breathing mask arrangement to be supported on the surface of the face of the user of the mask by way of the zones of thickened cross-section.

As an alternative to the above-described measure—or when the radial section geometry of the mask pad device is of a differing configuration in zone-wise manner—it is also possible for the zones of thickened cross-section to be such that they are supported on the surface of the face of the user of the mask or on an inward side of the sealing lip, which is remote from the surface of the face of the user of the mask.

The differing Shore hardnesses or moduli of elasticity of the mask pad device, in particular in the region of the zones of thickened cross-section, can also be furnished by elastomer compound material prepared in different ways being used to form the mask pad device. That differing elastomer compound material can be introduced through separate feed openings into a suitable mould cavity of a moulding tool. The elastomer materials prepared in different ways can be introduced in steps which occur in succession in respect of time.

The mask pad device according to the invention can be of such a nature that it can be fitted for example by way of a peripheral edge portion in sealing relationship to a dish-shaped or arch-shaped body in the form of a hard shell member. That makes it possible for the mask pad device to be removed from the hard shell member for cleaning or replacement purposes.

As an alternative to the measure described hereinbefore it is also possible for the mask pad device to be formed integrally with the dish-shaped or arch-shaped body. That avoids the formation of a gap region between the mask pad device and the dish-shaped or arch-shaped body.

Particularly good adaptability of the mask pad device according to the invention can be achieved in that the zones of thickened cross-section are suspended resiliently at least in portion-wise manner in the application direction. That resilient suspension of the zones of thickened cross-section can be achieved in particular by way of a bellows structure which for example can be in the form of a folding or rolling bellows. It is also possible for the face sealing lip to be connected to the zones of thickened cross-section by way of a folding or rolling bellows structure.

The mask pad device can be so designed that the radial cross-sections, that is to say the cross-sections of the mask pad device, vary.

The above-described mask pad device forms a component part of a breathing mask which, in the application position, engages over the nose and/or the mouth region of the user of a mask. It can be used in a corresponding configuration in relation to a nasal mask and also in relation to a mouth or full-face mask.

The configuration according to the invention of the cross-section of the elastomer structures can also be used in relation to a forehead contact element. Thus, in accordance with a further and also alternative concept, it is possible for forehead contact pads to be of such a configuration that the deformation characteristics thereof are imparted by elastomer zones of reduced Shore hardness or by zones of increased pore volume.

In regard to a process for the production of the mask pad device according to the invention, the object as set forth hereinbefore is attained by a process in which, in the context of a step of introducing elastomer material, the elastomer material is introduced into a sealing pad mould cavity, wherein the temperature distribution of the inside wall of the mould cavity and the mould closing time are so matched that the elastomer material which crosslinks in the mould cavity to form the sealing pad device enjoys differing Shore hardnesses.

It is possible for the crosslinking process to be retarded in a defined manner by adding to the elastomer material a catalysis blocker which, from a predetermined degree of crosslinking or crosslinking time, prevents further crosslinking. The catalysis blocker is preferably configured in such a way that it is activated for example by UV exposure or by microwave heating. The use of a catalysis or crosslinking blocker makes it possible in the region of those zones which involve a low degree of crosslinking, to maintain that condition over a sufficiently long period of time—in particular also regardless of a post-temperature control phase.

Preferably in that respect the temperature profile of the inside wall of the mould cavity is controlled in such a way that the sealing pad device formed in the mould cavity involves Shore hardness values which differ in the configuration thereof in the peripheral direction.

The temperature profile of the inside wall of the mould cavity is advantageously further controlled in such a way that the mask pad device involves lower Shore hardness values in a region which in the application position is near the forehead or the bridge of the nose.

It is possible for the partially non-crosslinked elastomer material to be sucked away or blown out and for the mask pad to be subjected to a post-tempering effect. In that way it is possible to form cavern or tube zones in the sealing pad device.

In a manner which is further particularly advantageous from the point of view of the operating procedure of the process, the temperature profile of the inside wall of the mould cavity is varied during the step of introducing the elastomer material, in such a way that it firstly involves a first, possibly substantially constant temperature distribution, while during the mould closing time the temperature distribution is altered in such a way that in selected zones of the mould cavity, lower degrees of crosslinking and thus lower Shore hardness values are achieved.

In particular it is possible for the temperature distribution of the moulding tool to be adapted in such a way that the temperature profile has a first high-temperature distribution during the step of introducing the elastomer material and over a subsequent holding time, wherein, after the expiry of that holding time, selected zones of the inside wall of the mould cavity are cooled to lower temperatures.

In regard to the tool aspect the object set forth hereinbefore is attained by a moulding tool for the production of a mask pad device which in a tool closing position has a mould internal cavity which is delimited by an inside wall of the mould cavity and which is complementary to the sealing pad device to be formed, and a heating device for heating the inside wall of the mould cavity, wherein the moulding tool is of such a configuration that a predetermined temperature profile occurs at the inside wall of the mould cavity for different zones of the mask pad device to be formed therein, said predetermined temperature profile resulting in degrees of crosslinking of differing magnitude of the elastomer material which hardens in the internal cavity of the mould.

The moulding tool according to the invention is preferably so designed that the temperature profile can be adjusted in such a way that the mould cavity temperature in a mould cavity portion for forming a portion of the mask pad device, which seals off the forehead region or the region of the bridge of the nose, is lower than the temperature in a mould cavity portion provided for forming a top lip or chin sealing region of the mask pad device.

An embodiment of the moulding tool, which is advantageous in regard to a particularly desirable temperature distribution of the inside wall of the mould cavity, is afforded if the moulding tool is provided with cooling passages for cooling selected portions of the moulding tool, for example by way of a cooling medium which is introduced controlledly in respect of time.

In accordance with a further aspect the invention also concerns a sealing structure and a process for the production thereof. In particular the invention concerns sealing structures for sealingly bridging over or sealing off a gap region, for example in relation to tube connections, housing devices, and door and window arrangements.

Usually sealing structures of that kind have a sealing surface portion which is made from an elastomer material and which bears in elastically yielding relationship against a contact surface.

The problem with sealing structures of that kind is that under some circumstances the required sealing effect is achieved only when comparatively high pressures in relation to surface area are involved.

The object of the invention is to provide a sealing structure which is convenient to manufacture from production-engineering points of view and which is distinguished by a high sealing action and a high level of adaptability.

According to the invention that object is attained by a sealing structure comprising a base body made from an elastomer profile material, wherein the base body has a profile cross-section with at least one zone of thickened cross-section and the elastomer material is processed in such a way that the Shore hardness of the profile material is higher in the edge region of the zone of thickened cross-section than in the core or in the region near the core of the zone of thickened cross-section.

By virtue thereof it is advantageously possible to provide a sealing structure which is distinguished by a high level of adaptability even in the region of the zone of thickened cross-section.

In accordance with a particularly preferred embodiment of the invention the sealing structure is designed in such a way that it has gel-like material properties in the region of the zones of thickened cross-section. In accordance with a particularly preferred embodiment of the invention the different material properties in the region of the zone of thickened cross-section can be achieved in that hardening of the profile material is effected in such a way that the profile material has differing degrees of material crosslinking in zone-wise manner.

The profile cross-section of the sealing structure can be such that the zone of thickened cross-section immediately adjoins an integral sealing lip.

The differing Shore hardnesses or moduli of elasticity of the profile material, in particular in the region of the zone of thickened cross-section, can be achieved by the sealing structure being made from elastomer mixtures prepared in different ways (compound material). Those different elastomer compound systems can be introduced through separate feed openings into a mould cavity of a moulding tool, in particular into an extrusion passage. The infeed of the differently prepared elastomer compound mixtures can be effected in steps which occur in succession in respect of time.

The sealing structure according to the invention can be so designed that for example it is provided in the form of a peripherally extending sealing ring in relation to a tube connection.

In regard to a process for the production of the sealing structure according to the invention, the above-indicated object is attained by a process in which in the context of a step of introducing elastomer material the elastomer material is introduced into a sealing structure mould cavity, heating of the elastomer material in the mould cavity being effected in adapted manner such that the profile material in the region of a zone of thickened cross-section acquires a lower degree of crosslinking than in the edge region of the zone of thickened cross-section or remaining thin-wall portions of the sealing structure.

It is possible for the crosslinking operation to be definedly retarded by adding to the profile material a catalysis blocker which prevents further crosslinking as from a predetermined degree of crosslinking or crosslinking time. That catalysis blocker is preferably configured in such a way that it is activated for example by UV exposure or by microwave heating. The use of a catalysis or crosslinking blocker makes it possible in the region of those zones with a low degree of crosslinking to maintain that condition over a sufficiently long period of time, in particular also irrespective of a post-temperature control phase.

Preferably the temperature profile of a mould cavity internal wall which is provided for forming the sealing structure is matched in such a way that the sealing structure formed in the mould cavity has portions of differing Shore hardness.

It is possible for the elastomer material which is possibly non-crosslinked in the region of the zone of thickened cross-section to be at least partially sucked away or blown out and for the sealing structure then to be subjected to a post-temperature control operation. In that way it is possible to provide cavern or tube zones in the sealing structure.

Further details and features of the inventions will be apparent from the description hereinafter with reference to the drawing.

### BRIEF DESCRIPTION OF THE FIGURES

FIG. 1 is a view in cross-section through a sealing pad device in accordance with a first embodiment of the invention with a zone of thickened cross-section and regions contained therein of differing Shore hardness,

FIG. 2 shows a sectional view through a sealing pad device also with a zone of thickened cross-section and regions formed therein of differing material properties,

FIG. 3 shows a diagram to illustrate the differing temperature distribution of an inside wall of a mould cavity of a moulding tool for the production of a sealing pad device with a Shore hardness which varies in the peripheral direction,

FIG. 4 shows a sectional view to illustrate the cross-section of a sealing pad device with an insert element which is arranged in the interior thereof adjacent to a sealing lip and which is crosslinked gel-like,

FIG. 5a shows a variant of the insert element 16 in accordance with which the gel-like crosslinked body thereof is of a horseshoe-like configuration and extends in the application position over the bridge of the nose of the user of the mask,

FIG. 5b shows a variant of the insert element 16 wherein the gel-like crosslinked body thereof is of a configuration such as to follow the sealing lip in a ring-like manner, extending around the mouth and/or nose opening,

FIG. 6a shows a view in section through a sealing pad device also with a zone of thickened cross-section and filled with a gel or foam material and which here is formed by a pocket portion formed integrally with the sealing lip device, wherein the pocket portion is covered by a frame element and the sealing lip device is provided with a shell body which is produced integrally with the sealing lip device from an elastomer material,

FIG. 6b is a view in section through a sealing pad device similar to FIG. 6a, wherein the frame element forms a connecting structure for coupling a mask shell for covering the nose region,

FIG. 6c shows a further view in section through a sealing pad device also with a zone of thickened cross-section and filled with a yielding gel or foam material,

FIG. 7 is a simplified perspective view of a cushion body comprising a gel or foam material for supporting a breathing mask,

FIG. 8 shows a simplified side view to illustrate a possible configuration of a cushion body as shown in FIG. 7 on the surface of the face of a user of a mask,

FIG. 9 shows a simplified perspective view of a gel or foam cushion body which is subdivided into various segments, wherein the segments have different mechanical properties, in particular are of different Shore hardnesses and the interfaces are of an organically uneven configuration,

FIG. 10 shows a three-dimensional representation to illustrate a variant of the cushion body with a portion which is cut out in the region bridging over the bridge of the nose,

FIG. 11 is a view in section through a cushion body segment for bridging over the region of the bridge of the nose,

FIG. 12 is a sketch to illustrate the configuration of a cushion body on the surface of the face of a patient,

FIG. 13 shows a sketch to illustrate a cushion body segment which fits on the upper lip region of a patient,

FIG. 14 shows a perspective view of a sealing lip device including associated mask base body, wherein the sealing lip device has a peripheral pocket portion which is filled with a gel or foam material and in the region of the sealing lip peripheral zone identified by a stepped configuration supports the mask base body on the surface of the face of the patient,

FIG. 15 is a perspective view of a sealing lip device similar to FIG. 14 including associated mask base body, wherein the sealing lip device has a peripheral pocket portion which is filled with a gel or foam material and in the region of the sealing lip peripheral zone identified by a stepped configuration supports the mask base body on the surface of the face of the patient and is provided in the region of the bridge of the nose with an opening, or is interrupted, so that in that zone no support is provided on the bridge of the nose by way of the gel or foam material,

FIG. 16 shows a perspective view of the sealing lip device illustrated in FIG. 15 to illustrate the partially interrupted peripheral pocket portion,

FIG. 17 shows a perspective view of a breathing mask with a pivotably movably connected forehead support device and a sealing lip device including associated mask base body, as shown in FIG. 14 or 15,

FIGS. 18a to 18e are views in section of variants of forehead support pads, in particular for use in conjunction with a breathing mask, for example as shown in FIG. 17, wherein the forehead support pads have zones of thickened cross-section which are filled with a gel or foam material, and

FIG. 19 shows a perspective view of a portion of a sealing structure according to the invention with a zone of thickened cross-section and regions provided therein of low Shore hardness.

### DETAILED DESCRIPTION OF THE FIGURES

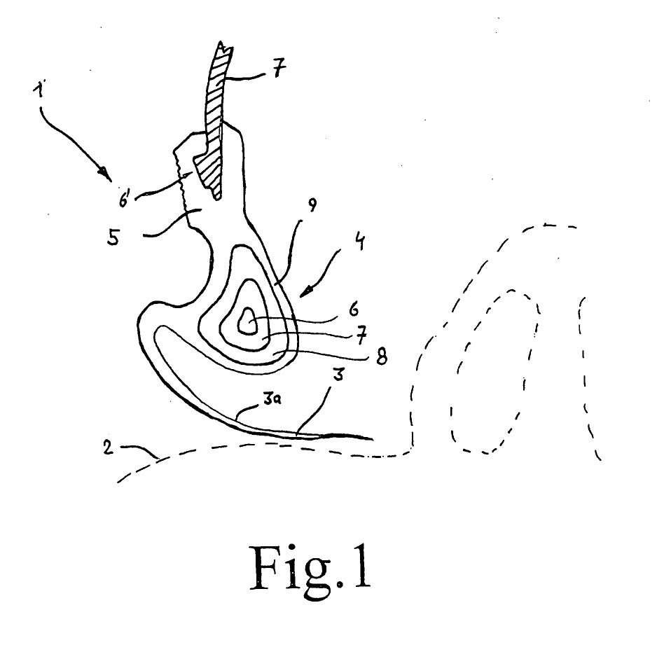

The sealing pad device 1 shown in FIG. 1 includes a sealing lip 3 which in the application position fits on a surface 2 of the face which is indicated here.

The mask pad device 1 further includes a zone 4 of thickened cross-section, which in this embodiment is arranged between an upper peripheral edge 5 and the sealing lip 3.

The zone 4 of thickened cross-section is of such a configuration that the Shore hardness of the material forming the zone of thickened cross-section varies. The material zones indicated here are of an almost gel-like character. The Shore hardness of the furthest inwardly disposed material zone 6 is lower than that of the adjoining material zone 7 which in turn is of a lower Shore hardness than the adjoining material zone 8. The outside region 9 of the zone of thickened cross-section is made from an elastomer material which is substantially completely crosslinked, and is of substantially the same Shore hardness as the sealing lip 3.

The differing material properties in the region of the zone 4 of thickened cross-section are determined by the temperature profile of a moulding tool provided for the production of the mask pad device 1 and by limiting the residence time of the mask device which has hardened sufficiently at least in the region near the mould cavity, in the moulding tool.

It is possible for the crosslinking process to be definedly retarded by the addition to the elastomer material of a catalysis blocker which prevents further crosslinking as from a predetermined degree of crosslinking or a predetermined crosslinking time. The catalysis blocker is preferably configured in such a way that it is activated for example by UV exposure or by microwave heating. The use of a catalysis or crosslinking blocker makes it possible, in the region of those zones involving a low degree of crosslinking, to maintain that state over a sufficiently long period of time—in particular also irrespective of a post-temperature control phase.

In the case of the mask pad device 1 illustrated here the sealing lip 3 is coupled to the zone 4 of thickened cross-section in such a way that, in the position of application of the mask pad device 1, the zone 4 of thickened cross-section can possibly seat on an inward side 3a of the sealing lip 3. In that way the mask pad device 1 can be supported on the surface 2 of the face by way of the zone 4 of thickened cross-section, in which case only comparatively low surface contact pressures are involved, by virtue of the particular properties of the zone 4 of thickened cross-section.

With this embodiment, by means of the zone 4 of thickened cross-section, it is also possible for the sealing lip 3 to be additionally urged against the surface of the face of the user of the mask, in particular in the critical regions such as for example the region of the bridge of the nose.

Here, provided in the region of the upper peripheral edge 5 is a coupling structure 6 by way of which the mask pad device 1 can be coupled in sufficiently sealing relationship to a hard shell member 7 which is only indicated here and which forms a dish-shaped or arch-shaped body.

The mask pad device 1 illustrated here is made from a two-component silicone material, wherein the material zone 6 is substantially not hardened. The material zones 7 and 8 are partially hardened gel-like, the degree of crosslinking of the material zone 8 being greater than the degree of crosslinking in the material zone 7.

The higher degrees of crosslinking in the edge region of the mask pad device 1 are achieved in particular by the high degree of heating of the silicone material adjoining a wall of the mould cavity.

Irrespective of the above-described configuration of the zone 4 of thickened cross-section—or in a particularly advantageous manner in combination therewith—it is possible for the sealing lip 3 to be such that it involves Shore hardness values which differ in its peripheral configuration. Those differing Shore hardness values can also be achieved by arbitrarily establishing the temperature profile of a moulding tool provided for forming the mask pad device 1, in the region of the inside wall of the mould cavity thereof.

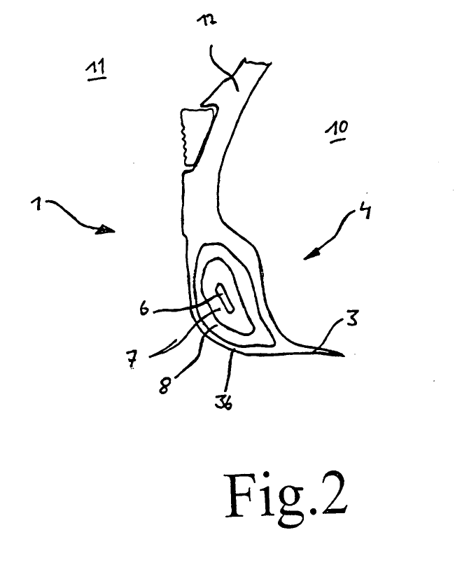

FIG. 2 shows a further embodiment of a mask pad device 1 which here is formed integrally with a dish-shaped or arch-shaped body 12 separating the internal space 10 of the mask from the ambient region 11.

The zone 4 of thickened cross-section which is also provided in this second embodiment also has material zones 6, 7, 8 which differ in respect of the Shore hardness prevailing there. In this embodiment the zone of thickened cross-section is fitted on to the surface of the face (not shown here) of the user of the mask by way of a completely crosslinked outside wall 3b which goes into the sealing lip 3.

The sealing lip 3 is here formed only as a small sealing lip portion which advances radially inwardly with respect to the nose and/or mouth opening.

Although it is not shown here, it is possible for the zone 4 of thickened cross-section and/or the sealing lip 3 to be coupled to the dish-shaped or arch-shaped body 12 by way of folding structures so that this can provide a still further improvement in the adaptability of the mask pad device 1 to the individual facial structure of the user of the mask.

The zone 4 of thickened cross-section can be of such a configuration as to extend completely around the device, with a possibly varying cross-sectional geometry. As an alternative thereto however it is also possible for the zone of thickened cross-section in the mask pad device 1 to be formed only in the region of the part which in the position of application is near to the forehead or near to the bridge of the nose.

It is also possible for differing radial section geometries to be provided in the peripheral direction of the mask pad device 1, in such a way that for example in the region near the top lip or the chin, the cross-section through the mask pad device 1 substantially corresponds to the structure diagrammatically shown in FIG. 2, whereas in the region of the mask pad device 1 near the forehead or the bridge of the nose, the cross-section of the mask pad device 1 substantially corresponds to the cross-section shown in FIG. 1.

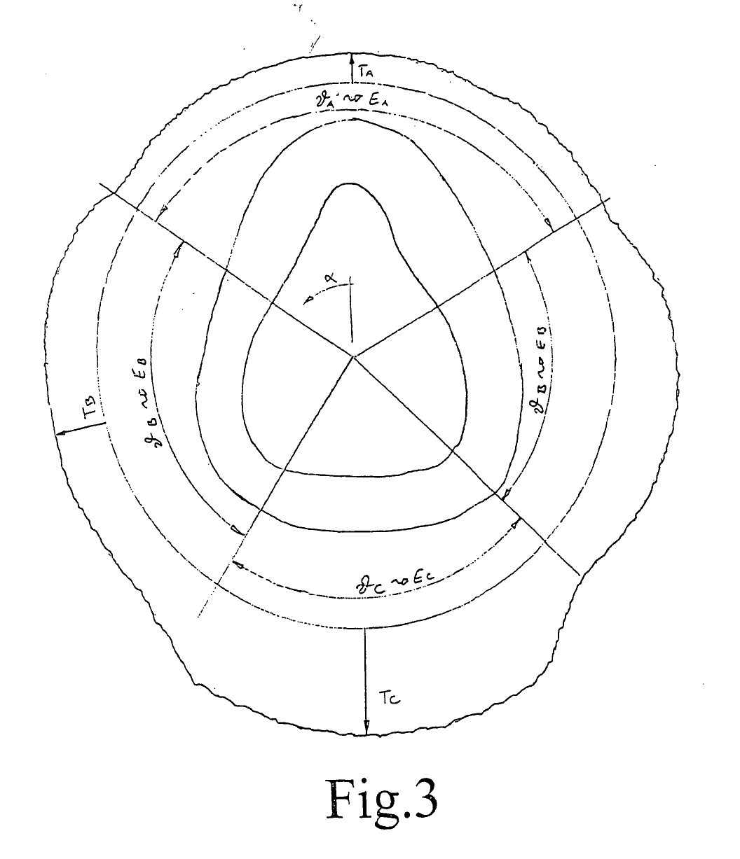

FIG. 3 shows in the manner of a polar diagram the temperature configuration of an inside wall of the mould cavity, adjacent to the sealing lip device 3 and in particular the zone 4 of thickened cross-section. As can be seen from that polar diagram, prevailing in a polar region which is here identified as A is a comparatively low average temperature TA which results in a lower degree of crosslinking of the elastomer material of the mask pad device 1 than the temperatures TB and TC in the regions B and C.

The temperature TC in the region θC exceeds the temperature TB in the region θB.

The temperature in the region θA substantially determines the degree of crosslinking and thus the Shore hardness of the sealing lip 3 in a region near the forehead or bridge of the nose.

The temperature TB in the regions θB substantially determines the Shore hardness in the region of the sealing lip 3, which is near the cheeks or the sides of the nose. The temperature TC substantially determines the Shore hardness of the sealing lip 3 in its peripheral portion which fits on the chin or top lip region of the wearer of the mask.

The temperature distribution illustrated here can be altered during the residence time of the elastomer material in the corresponding mould cavity of a moulding tool. The change in the temperature profile in the mould cavity of the moulding tool can be produced by altering the heating power or by portion-wise cooling of the moulding tool.

Cooling and/or heating members can be provided both in the region of the external tools and also in the region of the mould core tools which in the closed position of the moulding tool are accommodated in the external tools, thereby leaving the sealing pad mould cavity.

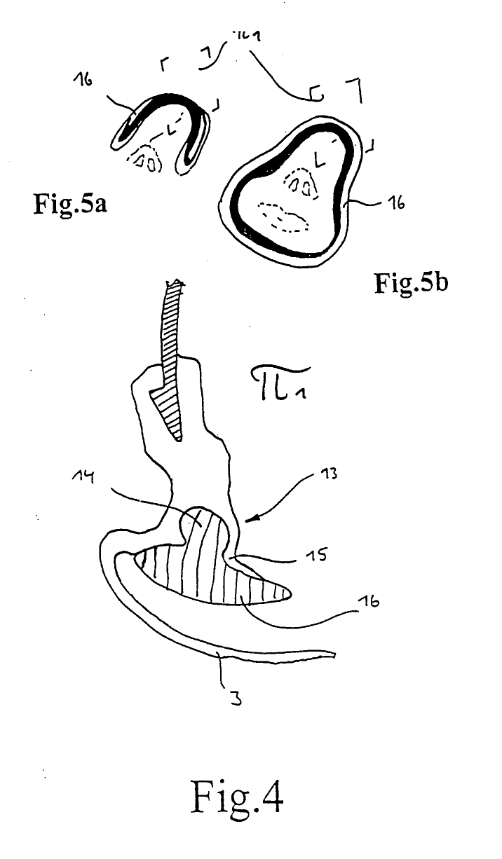

The sealing pad device shown in FIG. 4 includes an insert element 16 which is made from an elastomer material which is hardened gel-like and which has a surface skin. That insert element is arranged by way of a fixing structure 13 in the inside region of the sealing pad device. The fixing structure 13 is formed integrally with the sealing pad device by way of profiling of the sealing pad device. The profiling is such that a bead portion 14 of the insert element 16 is held by a holding lip portion 15. A portion of the insert element 16, which is towards the sealing lip 3, is such that it can possibly fit on an inward side of the sealing lip 3.

It is possible for the fixing structure to be of such a configuration in the inside region of the sealing pad device that insert elements of different configurations can be coupled thereto. It is possible for a plurality of sealing pad-compatible insert elements in gel, foam and/or tube form to be provided and for such insert elements to be selected according to the specific situation of use involved and for a breathing mask to be suitably fitted therewith. It is possible to store at least one variant of an at least partially preshaped, preferably gel-like insert element which can then be put for example by heating into a sufficiently plasticised condition in which the insert element can be adapted to the individual facial structure of the user of the mask.

The diagrammatic view in FIG. 5a shows a variant of the insert element 16 in which the gel-like crosslinked body thereof is of a horseshoe-like configuration and in the application position extends over the bridge of the nose of the user of the mask.

The diagrammatic view in FIG. 5b shows a variant of the insert element 16 in which the gel-like crosslinked body thereof is of a ring-like configuration, following the sealing lip, extending around a mouth and/or nose opening.

The cross-section of the insert element 16 in the region of the sectional plane π corresponds for example to the cross-section shown in FIG. 4.

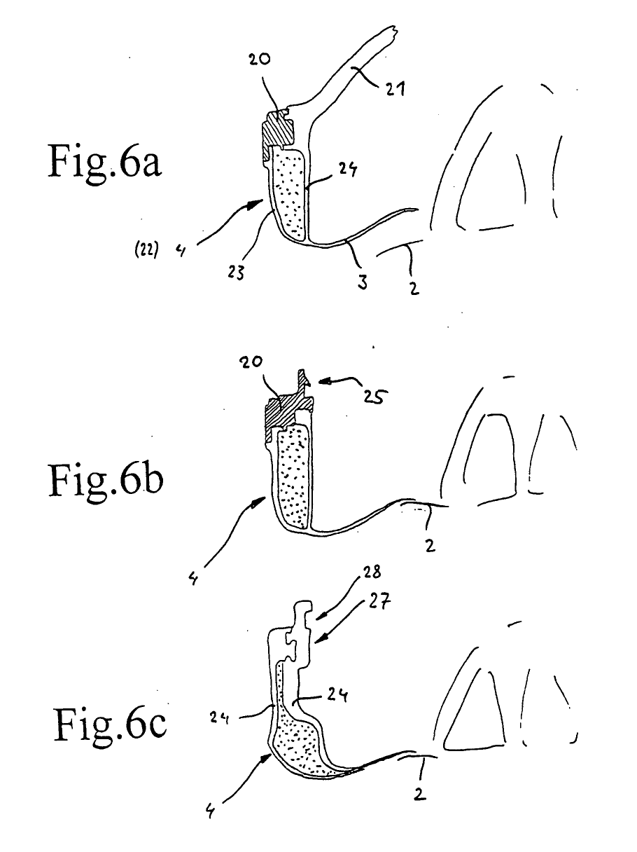

FIG. 6a shows a view in section through a sealing lip device also with a zone of thickened cross-section and filled with a gel or foam material, the zone here being formed in a pocket portion 22 formed integrally with the sealing lip device, wherein the pocket portion 22 is covered by a frame element 20 and the sealing lip device 21 is provided with a shell body 21 which is produced integrally with the sealing lip device, in particular the sealing lip 3, from an elastomer material. The pocket portion 22 is defined by two wall portions which form part of the sealing lip device. The frame element 20 forms part of an application device for application of the sealing pad device against the face of a user of the breathing mask. Provided on the frame element are profiling configurations and detent structures which permit defined coupling of the sealing lip device to the frame element 20. The frame element can be made from a flexible material so as to permit further adaptation of the mask pad to the individual facial structure of a user of the mask. In the illustrated embodiment the frame element 20 forms a holding structure by which the pocket portion 22 is closed off. The frame element 20 can be glued without a gap to the sealing lip device.

FIG. 6b shows a view in section through a sealing pad device similar to FIG. 6a, wherein the frame element 20 forms a connecting structure 25 for coupling a mask shell which covers over the region of the nose and which is produced for example from POM. In this embodiment the frame element 20 also forms a holding structure by which the pocket portion 4 is closed.

FIG. 6c shows a further view in section through a sealing pad device also with a zone 4 of thickened cross-section and filled with a yielding gel or foam material. Similarly to the embodiment of FIG. 6a the sealing lip device includes two wall portions 23, 24 between which the gel or foam material is accommodated. The wall portions 23, 24 have a closure profiling 27 and are held together by same. The sealing lip device formed in that way can be mounted by way of a holding edge portion 28 to a hard shell member of a breathing mask.

FIGS. 6a, 6b and 6c show by way of indication the region of the nose of a patient. The cross-sectional configuration of the sealing lip device can vary in its configuration in the peripheral direction and can produce differing support characteristics and surface pressures. Preferably the surface area proportion of the skin contact zone of the sealing lip device, which is supported under the action of the gel or foam body, is in the range of between 18 and 54%. The surface area proportion of the skin contact zone, which is edged by the zone supported by the gel or cushion body, is preferably in the range of between 46 and 82%.

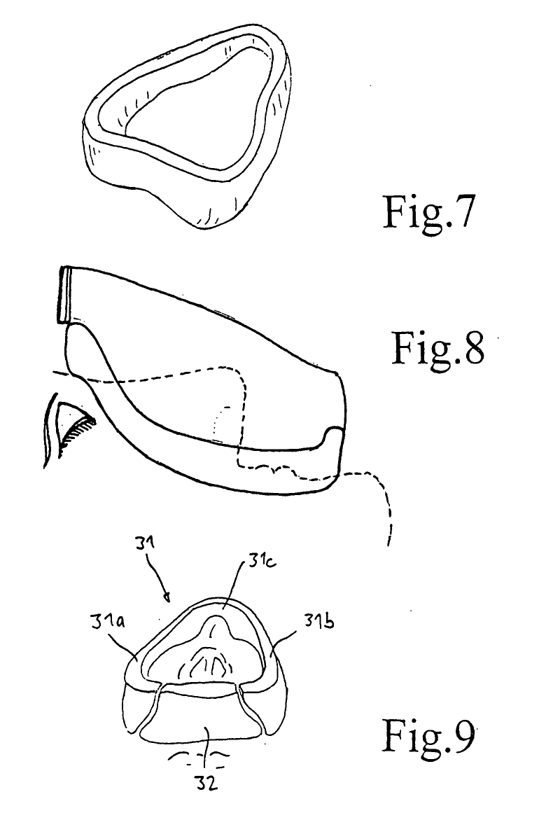

FIG. 7 shows a simplified perspective view of a profiled cushion body comprising a gel or foam material, for supporting a breathing mask, which involves varying cross-sections in its configuration in the peripheral direction. The cushion body is designed in such a way that it is of an only relatively small cross-sectional area in the region of the zone intended to bridge over the bridge of the nose. In the zones intended to bear against cheekbones or the cheek region the cushion body is of a relatively thick-walled and greatly deformable nature.

FIG. 8 shows a simplified side view to illustrate a possible configuration of a cushion body as shown in FIG. 7 on the surface of the face of a user of the mask. The cushion body can be received in a pocket portion of a sealing lip device, which is of an adequately complementary configuration, as is described with reference to FIGS. 6a, 6b and 6c and FIGS. 14, 15 and 16.

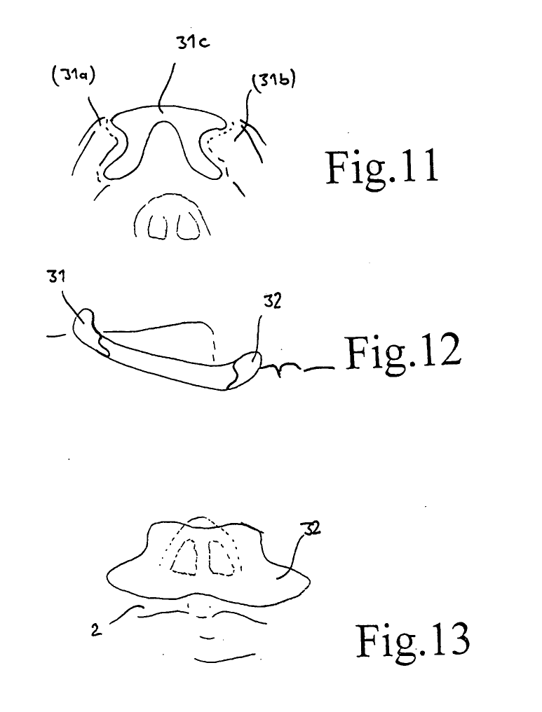

FIG. 9 shows a simplified perspective view of a gel or foam cushion body which is subdivided into various segments, wherein the segments have different mechanical properties and in particular are of differing Shore hardnesses and the interfaces are organically uneven. In the illustrated embodiment the cushion body is made from a gel material and subdivided into a flank support segment 31 and an upper lip support segment 32. The two segments are made from transparent gel material of differing colours, and accommodated in the installed condition in a peripheral pocket of a sealing lip device. The flank support element 31 has a left-hand flank portion 31a and a right-hand flank portion 31b which are here connected together in the region of the bridge of the nose, by way of a bridge zone 31c. It is also possible to provide a pre-profiled segment which is separate from the flank portions 31a, 31b in the region of the bridge zone 31c, as is shown in FIG. 11. It is also possible for the two flank portions 31a, 31b to be interrupted in the region of the bridge of the nose.

The segments 31a, 31b, 31c, 32 are preferably such that they bear against each other by way of interfaces of an uneven nature. The configuration of the interfaces can be adapted from aesthetic and structural-mechanical points of view and in that respect may have insect casing-like segment boundary contours.

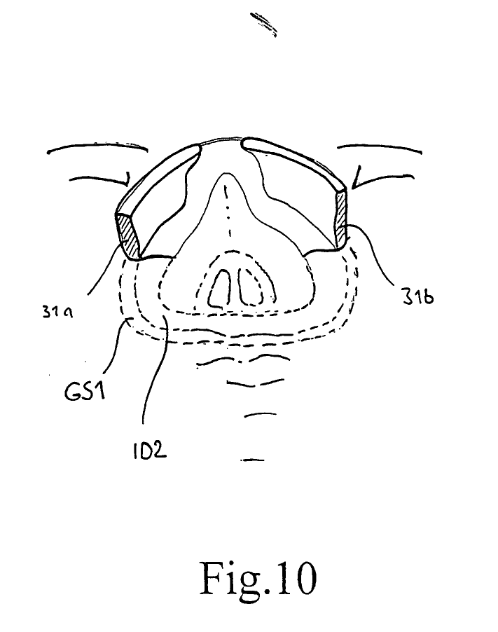

FIG. 10 shows a perspective view to illustrate a variant of the cushion body with a portion which is cut out in the bridge region of the bridge of the nose. The flank portions 31a, 31b form support systems for transmitting a mask support force to the gel or foam body support zone G/S1. That gel or foam body support zone G/S1 edges an inner lip contact zone ID2 which extends over the upper lip or chin region as well as the region of the bridge of the nose. That cushion body can be fitted into a pocket portion of a sealing lip device.

FIG. 11 shows a view in section of a cushion body segment 31c which bridges over the region of the bridge of the nose and which is made from a particularly soft, only slightly crosslinked gel material and which extends over the bridge of the nose. The cushion body segment 31c is such that it has connecting surfaces which permit a mechanically advantageous transition to the side flank segments 31a, 31b.

FIG. 12 shows a sketch to illustrate the transitional region between a cushion body segment 31c and a side flank segment 31a, as well as generally the configuration of such a cushion body, formed from a plurality of segments, on the surface of the face of a patient. The respective softer segment forms a terminal portion which engages under the harder segment.

FIG. 13 shows a sketch to illustrate a cushion body segment 32 which fits on the upper lip region of a patient, as is provided in the case of the segmented cushion body shown in FIG. 12. The cushion body segments preferably comprise a gel or elastomer material with a low degree of cross-linking and as such are accommodated in pocket portions of complementary configuration in directly mutually abutting relationship or separated from each other by limb portions.

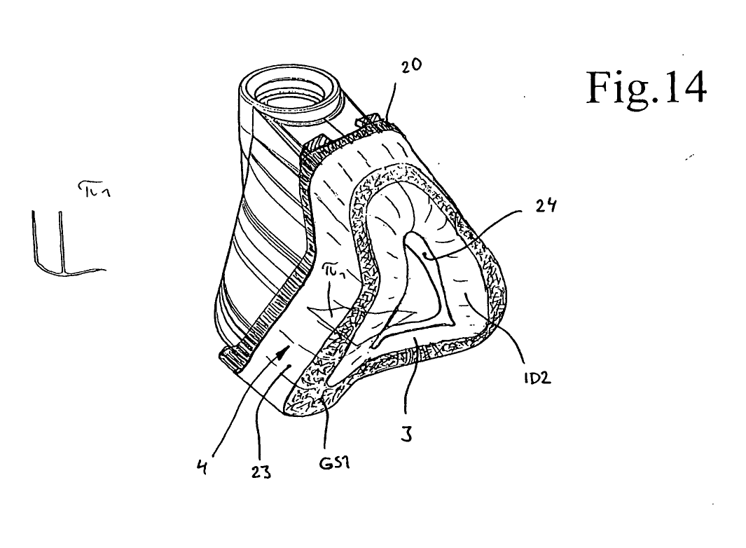

FIG. 14 shows a perspective view of a sealing lip device including the associated mask base body, wherein the sealing lip device has a peripheral pocket portion which is filled with a gel or foam material to provide a cushion body (see FIGS. 6a, 6b and 6c). In the region of the sealing lip peripheral zone which is identified by a stepped configuration with randomly oriented hatching the sealing lip device which is formed in that way supports the mask base body against the surface of the face of the patient in the zone GS1 (see also FIG. 10). The inner region of the sealing lip device 3 bears against the surface of the face of the user of the mask, substantially independently of the mask contact pressure forces, by way of the zone ID2.

The peripheral pocket portion 4 is enclosed by the wall 23. The pocket which is surrounded by the wall 23 and which is formed in conjunction with an inner peripheral wall 24 is covered by a frame element 20. Mask contact pressure forces can be directly applied to the gel or cushion material accommodated in the pocket portion 4, by way of the frame element 20.

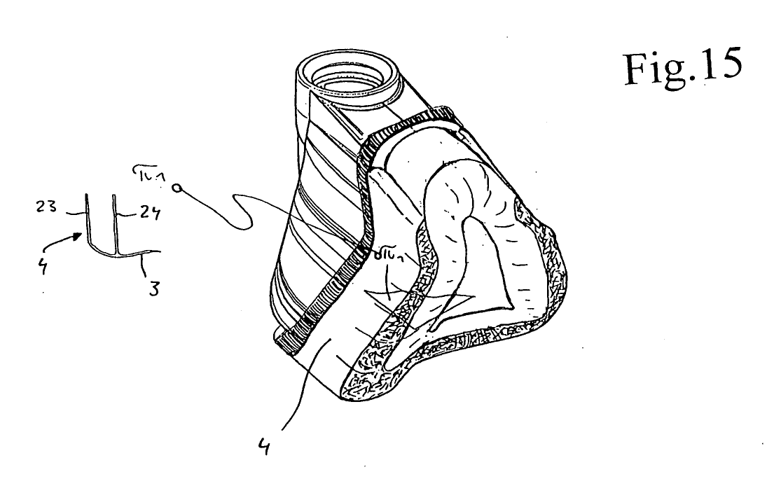

FIG. 15 shows a perspective view of a sealing lip device similar to FIG. 14 including associated mask base body, wherein the sealing lip device has a peripheral pocket portion which is filled with a gel or foam material and which, in the region of the sealing lip peripheral zone which is identified with a stepped configuration, supports the mask base body against the surface of the face of the patient. In the region of the bridge of the nose the cushion body is provided with a recess or is interrupted so that this zone does not involve any support on the bridge of the nose by way of the gel or foam material.

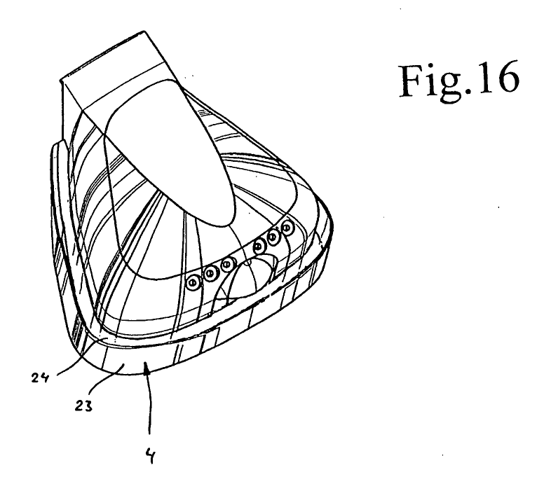

FIG. 16 shows a perspective view of the sealing lip device of FIG. 15 to illustrate the peripheral pocket portion 4. The material provided for forming the cushion body can be introduced in non-shaped condition into that peripheral pocket portion and definedly crosslinked in the pocket portion. It is also possible for pre-shaped cushion bodies, in particular segmented cushion bodies, to be fitted into the pocket portion and secured therein for example by a frame element.

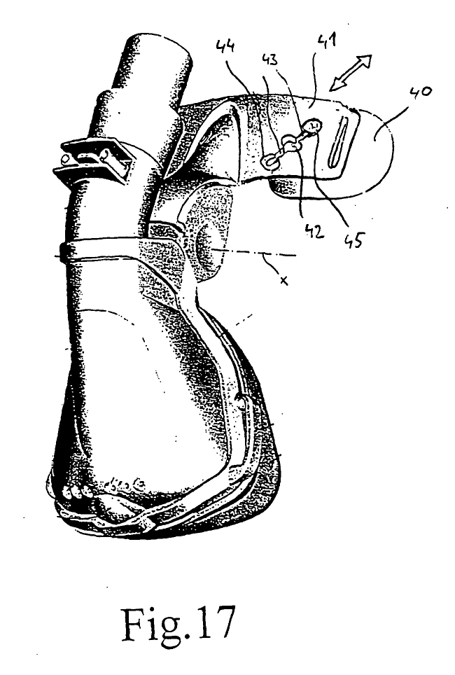

FIG. 17 shows a perspective view of a breathing mask with a pivotably movably connected forehead support device and a sealing lip device including associated mask base body, as illustrated in FIG. 14 or FIG. 15. Details of that breathing mask are described in patent application PCT/EP02/02877. The disclosure of that patent application is incorporated into the present application by virtue of that reference. This breathing mask includes forehead pads 40 which are made from an elastomer material and are mounted to a forehead support device 41.

Fixing of the forehead pads 40 is effected by way of a plug-in holder which has a central receiving opening 42 and adjoining retaining or detent tracks 43 which open into fixing recesses 44. A retaining or detent head portion 45 of the forehead pad 40 can engage into those fixing recesses 44 and secure the forehead pad 40 in that position. The retaining or detent tracks 43 are so designed that the forehead pad 40 can be fixed to the forehead support device 41 in a position which is suited to the user of the mask.

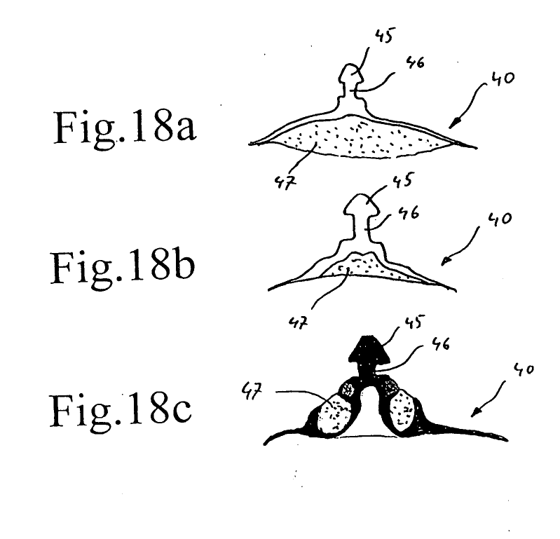

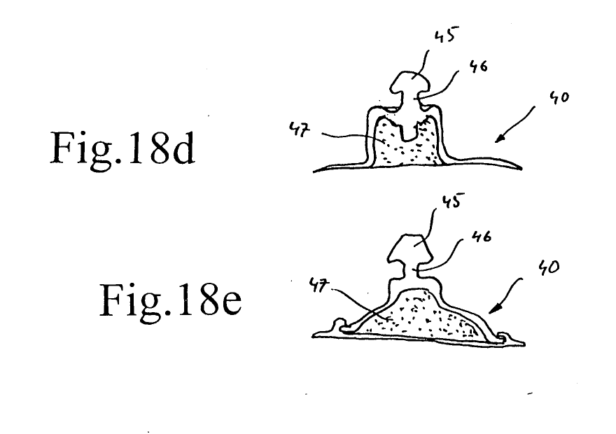

FIGS. 18a to 18e show views in section of variants of forehead support pads 40 in particular for use in conjunction with a breathing mask for example as shown in FIG. 17, wherein the forehead support pads 40 have zones of thickened cross-section which are filled with a gel or foam material. The forehead support pads 40 include a support stem 46 and a retaining or detent head portion 45. The support stem 46 and the retaining or detent head portion 45 are of such a configuration that they permit a defined tilting movement of the contact zone provided for bearing against the forehead of a patient. Provided in the region of that contact zone are profiling portions which prevent a reduced pressure from being built up.

The pads 40 are provided with a gel or foam material portion 47. That portion 47 and the elastomer walls surrounding same are so adapted as to afford a defined surface pressure distribution and/or a defined hinge characteristic.

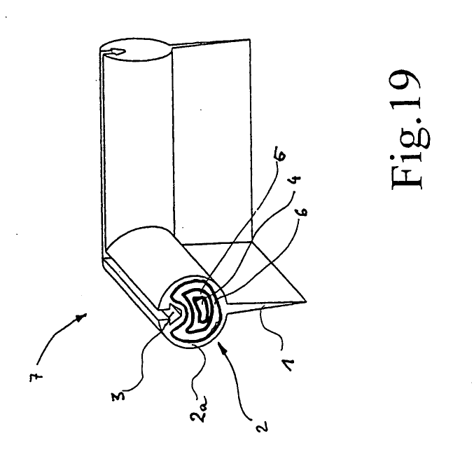

The sealing structure 7 shown in FIG. 19 includes a sealing lip 1 and a zone 2 of thickened cross-section which is adjoining the sealing lip. Provided in the region of the zone 2 of thickened cross-section is a fixing profiling 3, by way of which the sealing structure can be fixed to a holding profile member.

In the region of the zone 2 of thickened cross-section the profile material of the sealing structure is processed in such a way that the Shore hardness of the profile material in the core region 4 of the zone of thickened cross-section is lower than in the edge region 2a of the zone of thickened cross-section. In the core region 4 the profile material has substantially gel-like material properties. In the regions 5, 6 between the core region 4 and the edge region 2a the profile material is crosslinked in such a way that here there are Shore hardnesses which are admittedly higher than in the core region 4, but lower than in the edge region 2a. In this embodiment the Shore hardness in the inner region 5 adjacent to the core region 4 is lower than the Shore hardness in the adjoining annular region 6.

The sealing structure according to the invention is distinguished in that it has a partially hardened zone of thickened cross-section. The sealing structure according to the invention is preferably made from an addition-crosslinked material, in particular silicone material, in the form of an injection moulding or extrudate. The desired degrees of crosslinking can be established in a narrow tolerance range by matching control of the temperature profile of a mould cavity or extrusion passage wall. In accordance with a particularly preferred embodiment of the invention the crosslinking reaction is actively prevented in the region of the zone of thickened cross-section so that the desired material properties of the zone of thickened cross-section can be maintained with long-term stability.

The crosslinking reaction can be stopped in particular by the catalysis reaction being prevented by the addition or activation of a catalysis block. Activation of the catalysis block can be brought about in particular by UV light, by microwaves, by electromagnetic radiation or also by injection of a catalysis block into the region of the zone of thickened cross-section. In a particularly preferred embodiment the sealing structure according to the invention is produced from an addition-crosslinked LSR-silicone, wherein the region of the sealing lip illustrated here is thoroughly hardened and the region of thickened cross-section adjoining the sealing lip 1 has zones with a reduced degree of crosslinking, in particular gel-elastic properties. The zone 2 of thickened cross-section has a completely crosslinked external skin in its edge region 2a whereas the material in the core region 4 is almost non-crosslinked.

1. A mask pad device for a breathing mask comprising a receiving opening which in the position of application of the breathing mask coincides at least with the nose and/or mouth opening region of a user of the mask, and a sealing lip which is formed from an elastomer material and which extends around the receiving opening and which in the application position fits on the surface of the face of the user of the mask, characterised in that at least one zone of thickened cross-section is provided in the mask pad and that the mask pad material of said zone of thickened cross-section has different material properties in such a way that the Shore hardness of the mask pad in the edge region of the zone of thickened cross-section is higher than in the region which is at the core or at least near the core, of the zone of thickened cross-section.

2. A mask pad device according to claim 1 characterised in that the Shore hardness of the mask pad in the region of the zones which in the application position are near the forehead or the bridge of the nose is lower than in the region of the peripheral zones near the cheeks, top lip or sides of the nose.

3. A mask pad device according to claim 2 characterised in that in the core region of the zones of thickened cross-section the material has gel-like material properties.

4. A mask pad device according to claim 1 characterised in that the different material properties in the region of the zones of thickened cross-section are caused by differing degrees of crosslinking of the material.

5. A mask pad device according to at least one of claim 1 characterised in that the zones of thickened cross-section adjoin the sealing lip.

6. A mask pad device according to claim 1 characterised in that the zone of thickened cross-section in the application position is seated at least portion-wise on the surface of the face of the user of the mask.

7. A mask pad device according to claim 1 characterised in that the zone of thickened cross-section in the application position is seated at least portion-wise on the inward side of the face sealing lip, which is remote from the surface of the face of the user of the mask.

8. A mask pad device according to claim 1 characterised in that the zones of thickened cross-section are formed from at least two elastomer compound materials which are prepared differently.

9. A mask pad device according to claim 1 characterised in that it is adapted to be fitted to a dish-shaped body formed by a hard shell member.

10. A mask pad device according to claim 1 characterised in that the sealing pad device is formed integrally with the dish-shaped body.

11. A mask pad device according to claim 1 characterised in that the zones of thickened cross-section is resiliently yieldingly suspended in the application direction at least in portion-wise manner.

12. A mask pad device according to claim 1 characterised in that the sealing lip is resiliently coupled by way of a folding structure to the zone of thickened cross-section.

13. A breathing mask comprising a dish-shaped body which in the application position engages over the nose and/or mouth region of a user of the mask and a mask pad device according to claim 1.

14. A breathing mask according to claim 13 characterised in that the dish-shaped body is formed integrally with the sealing pad device.

15. A breathing mask according to claim 14 characterised in that the dish-shaped body is formed by a hard shell member.

16. A process for the production of a mask pad device of a breathing mask in which in the context of a step of introducing elastomer material, the elastomer material is introduced into a mask pad mould cavity, wherein the temperature distribution of the inside wall of the mould cavity and the mould closing time are so controlled that the elastomer material which is crosslinked to form the mask pad device in the mould cavity attains different Shore hardness values.

17. A process according to claim 16 characterised in that the temperature profile of the inside wall of the mould cavity is controlled in such a way that the sealing pad device formed in the mould cavity has different Shore hardness values in the configuration thereof in the peripheral direction.

18. A process according to claim 16 characterised in that the temperature profile is so controlled that the mask pad device attains lower Shore hardness values in a region which in the application position is near the forehead or the bridge of the nose.

19. A process according to claim 16 characterised in that the temperature profile of the inside wall of the mould cavity during the step of introducing elastomer material has a first temperature profile characteristic and that the temperature characteristic is altered during the mould closing time.

20. A process according to claim 19 characterised in that the temperature profile during the step of introducing elastomer material has a first, in particular constant high-temperature distribution, and that during the mould closing time selected zones of the inside wall of the mould cavity are cooled to lower temperatures.

21. A moulding tool for the production of a mask pad device comprising an internal mould cavity delimited in the tool closed position by an inside wall of the mould cavity and which is complementary with respect to the mask pad device to be formed, and a heating device for heating the inside wall of the mould cavity, characterised in that the moulding tool is so designed that a predetermined temperature profile is produced at the inside wall of the mould cavity.

22. A moulding tool according to claim 21 characterised in that the temperature profile can be adjusted in such a way that the mould cavity temperature in a mould cavity portion for forming a portion of the mask pad device, which seals off the forehead region or the region of the bridge of the nose, is lower than the temperature in a mould cavity portion provided for forming a top lip or chin sealing region of the mask pad device.

23. A moulding tool according to claim 19 characterised in that it includes cooling devices for cooling selected portions of the moulding tool.

24. A moulding tool according to claim 19 characterised in that the temperature profile is variable during the mould closing time.

25. A mask pad device for a breathing mask comprising a receiving opening which in the position of application of the breathing mask coincides at least with the nose and/or mouth opening region of a user of the mask, and a sealing lip which is formed from an elastomer material and which extends around the receiving opening and which in the application position fits on the surface of the face of the user of the mask, characterised in that at least one zone of thickened cross-section is provided in the mask pad and that the mask pad material of said zone of thickened cross-section is foamed in such a way that in the region of the zone of thickened cross-section the mask pad forms a foam cushion.

26. A mask pad device for a breathing mask comprising a receiving opening which in the position of application of the breathing mask coincides at least with the nose and/or mouth opening region of a user of the mask, and a sealing lip which is formed from an elastomer material and which extends around the receiving opening and which in the application position fits on the surface of the face of the user of the mask, characterised in that at least one zone of thickened cross-section is provided in the inner region of the mask pad and that the mask pad material of said zone of thickened cross-section has gel-like material properties, wherein the zone of thickened cross-section is formed by insertion of a gel-like crosslinked elastomer body into a fixing structure provided in the internal space of the mask pad device.

27. A mask pad device according to claim 26 characterised in that the gel-like crosslinked body thereof is of a horseshoe-like configuration and in the application position extends over the bridge of the nose of the user of the mask.

28. A mask pad device according to claim 26 characterised in that the gel-like crosslinked body thereof is of a ring-like configuration, following the sealing lip, extending around a mouth and/or nose opening.

29. A mask pad device for a breathing mask comprising a receiving opening which in the position of application of the breathing mask coincides at least with the nose and/or mouth opening region of a user of the mask, and a sealing lip which is formed from an elastomer material and which extends around the receiving opening and which in the application position fits on the surface of the face of the user of the mask, characterised in that provided in the mask pad is at least one receiving pocket portion and provided in said receiving pocket portion is a cushion body comprising a gel or foam material, wherein the configuration of the pocket portion is established such that the sealing lip device defines a skin contact zone (GS1) in which the sealing lip device is urged against the surface of the face by the cushion body.

30. A mask pad device according to claim 29 characterised in that the cushion body is subdivided into segments.

31. A forehead pad for a breathing mask comprising a forehead pad base body which is made from an elastomer material and has a coupling portion for fixing the forehead pad to a forehead support device and a stem portion for radially yieldingly mounting a forehead contact portion provided for bearing against a forehead surface, wherein the forehead pad has a zone of thickened cross-section and in said zone is provided with a gel or foam material.

32. A sealing structure comprising a base body made from an elastomer profile material, wherein the base body has a profile cross-section with at least one zone of thickened cross-section and the elastomer material is processed in such a way that the Shore hardness of the profile material is higher in the edge region of the zone of thickened cross-section than in the core or in the region near the core of the zone of thickened cross-section.

33. A sealing structure according to claim 32 characterised in that in the core region of the zone of thickened cross-section the material has gel-like material properties.

34. A sealing structure according to claim 32 characterised in that the differing material properties in the region of the zone of thickened cross-section are caused by differing degrees of material crosslinking.

35. A sealing structure according to claim 32 characterised in that it includes a sealing lip and the zone of thickened cross-section adjoins the sealing lip.

36. A sealing structure according to claim 32 characterised in that the zone of thickened cross-section is formed from at least two differently prepared elastomer compound systems.

37. A sealing structure according to claim 32 characterised in that the sealing structure has a fixing profiling.

38. A sealing structure according to claim 32 characterised in that the sealing structure has a folding bellows portion which is formed integrally with the zone of thickened cross-section.

39. A process for the production of a sealing structure in which in the context of a step of introducing elastomer material the elastomer material is introduced into a sealing structure mould cavity or sealing extrusion passage, wherein the temperature distribution in the sealing structure mould cavity or in the extrusion passage as well as the residence time are matched in such a way that the elastomer material crosslinking to form the sealing structure acquires differing Shore hardnesses in the region of a zone of thickened cross-section.

40. A process according to claim 39 characterised in that in the core region of the zone of thickened cross-section crosslinking of the profile material is retarded or blocked.

41. A process according to claim 40 characterised in that retardation of the crosslinking procedure is delayed by UV exposure.

42. A process according to claim 41 characterised in that retardation of the crosslinking procedure is delayed by microwave irradiation.

43. A process according to claim 42 characterised in that retardation of the crosslinking procedure is delayed by electromagnetic radiation.

44. A process according to claim 43 characterised in that crosslinking in the region of the zone of thickened cross-section is retarded by injection of a catalysis blocker into the core region.
